(19) United States
(12) Patent Application Publication
(10) Pub. No.: US 2026/0140687 A1
(43) Pub. Date: May 21, 2026

(54) ELECTRONIC DEVICE FOR SUPPORTING 3D DISPLAY IN MULTI-DISPLAY ENVIRONMENT AND OPERATING METHOD THEREOF

(71) Applicant: SAMSUNG ELECTRONICS CO., LTD., Suwon-si (KR)

(72) Inventors: Mugong BAE, Suwon-si (KR); Byeol PARK, Suwon-si (KR)

(73) Assignee: SAMSUNG ELECTRONICS CO., LTD., Suwon-si (KR)

(21) Appl. No.: 19/372,742

(22) Filed: Oct. 29, 2025

Related U.S. Application Data
(63) Continuation of application No. PCT/KR2025/014167, filed on Sep. 11, 2025.

(30) Foreign Application Priority Data
Sep. 13, 2024 (KR) 10-2024-0125908

(51) Int. Cl. G06F 3/14; H04N 13/139; H04N 13/302; H04N 13/349; H04N 13/359

(52) U.S. Cl. CPC G06F 3/1446; G06F 3/1454; H04N 13/139; H04N 13/302; H04N 13/349; H04N 13/359

(57) ABSTRACT

An electronic device may include: a memory including at least one storage medium configured to store instructions; and at least one processor including processing circuitry, the at least one processor configured to: with a connection to a plurality of display devices including a three-dimensional (3D) display device that supports 3D display, obtain a request for 3D display, based on the obtained request for 3D display, obtain image data in a 3D format according to multi-display mode information that indicates the plurality of display devices are in a multi-display mode, and transmit, to the 3D display device among the plurality of display devices, an image signal including the image data that allows the 3D display device to display a 3D image corresponding to the image data, wherein the multi-display mode is one of a display duplication mode and a display extension mode.

### CROSS-REFERENCE TO RELATED APPLICATIONS

This application is a continuation of International Application No. PCT/KR 2025/014167 designating the United States, filed on Sep. 11, 2025, in the Korean Intellectual Property Receiving Office and claiming priority to Korean Patent Application No. 10-2024-0125908, filed on Sep. 13, 2024, in the Korean Intellectual Property Office, the disclosures of each of which are incorporated by reference herein in their entireties.

### TECHNICAL FIELD

The disclosure relates to an electronic device and method for supporting a 3D display in a multi-display environment.

### BACKGROUND ART

Multi-display technology refers to a technology that provides an expanded or duplicated screen using a plurality of display devices (e.g., monitors). Multi-display technology increases user work efficiency, facilitates multitasking, and provides an immersive experience through a plurality of displays.

As display technology advances, various 3D display devices that provide 3D effects are being developed. These 3D display devices may implement a multi-display configuration together with other display devices (e.g., 2D display devices and/or 3D display devices). However, in a multi-display environment including a 3D display device, there is no technology for controlling the 3D display device, which reduces the usability of the 3D display device in a multi-display environment.

The above-described information may be provided as related art for the purpose of helping understanding of the disclosure. The foregoing cannot be claimed as, or used to determine, the prior art related to the disclosure.

### DISCLOSURE OF INVENTION

### Solution to Problems

In accordance with the present disclosure, an electronic device may include: a memory including at least one storage medium configured to store instructions; and at least one processor including processing circuitry, the at least one processor may be configured to: with a connection to a plurality of display devices including a three-dimensional (3D) display device that supports 3D display, obtain a request for 3D display, based on the obtained request for 3D display, obtain image data in a 3D format according to multi-display mode information that indicates the plurality of display devices are in a multi-display mode, and transmit, to the 3D display device among the plurality of display devices, an image signal including the image data that allows the 3D display device to display a 3D image corresponding to the image data, wherein the multi-display mode is one of a display duplication mode and a display extension mode.

According to an embodiment, the image signal may be a first image signal, the plurality of display devices may further include a two-dimensional (2D) display device that supports 2D display, the multi-display mode may be the display duplication mode, and the at least one processor may be further configured to: with a connection to the plurality of display devices including the 3D display device and the 2D display device, transmit, to the 2D display device, a second image signal including image data in a 2D format, the image data in the 2D format and the image data in the 3D format that may be image data for a same content.

According to an embodiment, the plurality of display devices may further include a two-dimensional (2D) display device that supports 2D display, the multi-display mode may be the display extension mode, and the at least one processor may be further configured to: with a connection to the plurality of display devices including the 3D display device and the 2D display device, identify whether a portion of an execution screen of the 2D display device may be moved to the 3D display device, based on identification that the portion of an execution screen of the 2D display device is moved to the 3D display device, convert image data in a 2D format that corresponds to the execution screen into image data in the 3D format to obtain the image data in the 3D format.

According to an embodiment, an execution screen corresponding to the image data in the 3D format may be displayed on an entire screen of the 3D display device.

According to an embodiment, the 3D display device may support both 3D display and 2D display, and the at least one processor may be further configured to: with the connection to the plurality of display devices including the 3D display device and the 2D display device, transmit, to the 3D display device, display mode information for switching a display mode of the 3D display device from a 2D display mode to a 3D display mode.

According to an embodiment, the image signal may include the display mode information.

According to an embodiment, the 3D display device may be a first 3D display device, the plurality of display devices may further include a second 3D display device that supports 3D display, the multi-display mode may be the display extension mode, and the at least one processor may be further configured to: with a connection to the plurality of display devices including the first 3D display device and the second 3D display device, obtain the image data in the 3D format based on first screen ratio information for a screen ratio of an image and second screen ratio information for a screen ratio of a first display screen of the first 3D display device and/or a screen ratio of a second display screen of the second 3D display device such that at least a first portion of the image is displayable on the first display screen and at least a second portion of the image is displayable on the second display screen.

According to an embodiment, the at least one processor may be further configured to: with the connection to the plurality of display devices including the first 3D display device and the second 3D display device, and based on the screen ratio of the image being identical to the screen ratio of the first display screen and/or the screen ratio of the second display screen, configure image data in the 3D format to be displayed on the first 3D display device or the second 3D display device.

According to an embodiment, the at least one processor may be further configured to: with the connection to the plurality of display devices including the first 3D display device and the second 3D display device and based on the screen ratio of the image being larger than the screen ratio of the first display screen and/or the screen ratio of the second display screen, obtain first partial image data in the 3D format corresponding to a first portion of the image and second partial image data in the 3D format corresponding to a second portion of the image.

According to an embodiment, based on the obtained first partial image data, a first 3D image corresponding to the first portion of the image may be displayed on the first 3D display device, and based on the obtained second partial image data, a second 3D image corresponding to the second portion of the image may be displayed on the second 3D display device.

In accordance with the present disclosure, a display device may include: a display that supports three-dimensional (3D) display; a memory including at least one storage medium configured to store instructions; and at least one processor including processing circuitry, the at least one processor may be configured to: with a connection to another display device and an electronic device, receive, from the electronic device, an image signal including image data in a 3D format that allows the display to display a 3D image corresponding to the image data, and display the 3D image based on the received image data, wherein the image data may be obtained by the electronic device according to multi-display mode information that indicates the display device and the another display device are in a multi-display mode, and the multi-display mode may be one of a display duplication mode and a display extension mode.

According to an embodiment, the image data may be first image data, the another display device may further include a two-dimensional (2D) display device that supports 2D display, the multi-display mode may be the display duplication mode, and the first image data may be for a same content as second image data that may be transmitted by the electronic device to the 2D display device.

According to an embodiment, the another display device may be a two-dimensional (2D) display device that supports 2D display, the multi-display mode may be the display extension mode, and the first image data of the 3D format is obtained by, based on identification that a portion of an execution screen of the another display device may be moved to the display, converting image data in a 2D format that corresponds to the execution screen into the image data in the 3D format as at least part of the received image data.

According to an embodiment, the at least one processor may be further configured to: with the connection to the another display device and the electronic device, display an execution screen corresponding to the image data in the 3D format on an entire screen of the display.

According to an embodiment, the display may support both 3D display and 2D display, and the at least one processor may be further configured to: with the connection to the another display device and the electronic device, receive, from the electronic device, display mode information for switching a display mode of the display from a 2D display mode to a 3D display mode.

According to an embodiment, the image signal may include the display mode information.

According to an embodiment, the display may be a first 3D display, the another display device may include a second 3D display that supports 3D display, the multi-display mode may be the display extension mode, and the image data in the 3D format may be received based on first screen ratio information for a screen ratio of an image and second screen ratio information for a screen ratio of a first display screen of the first 3D display such that at least a portion of the image may be displayable as a 3D image on the first display screen.

According to an embodiment, based on the screen ratio of the image being identical to the screen ratio of the first display screen, the image data in the 3D format may be displayable as the 3D image on the first display screen or a second display screen of the second 3D display.

According to an embodiment, the image data in the 3D format may include first partial image data in the 3D format corresponding to a first portion of the image.

According to an embodiment, the display may be configured to display a first 3D image corresponding to the first portion of the image on the display.

### BRIEF DESCRIPTION OF DRAWINGS

The same or similar reference denotations may be used to refer to the same or similar elements throughout the specification and the drawings.

FIG. 1 is a view illustrating a display system including a display device according to an embodiment of the disclosure;

FIG. 2 illustrates a configuration of an electronic device for controlling a multi-display including a 3D display device according to an embodiment of the disclosure;

FIG. 3 is a flowchart illustrating a method of controlling a multi-display including a 3D display device by an electronic device according to an embodiment of the disclosure;

FIG. 4 is a signal flowchart illustrating a procedure in which the electronic device controls a display device in a second multi-display environment, according to an embodiment of the disclosure;

FIGS. 5A and 5B are views illustrating a screen of a display device when a display duplication mode is applied in a second multi-display environment, according to an embodiment of the disclosure;

FIGS. 6A and 6B are views illustrating a screen of a display device when a display extension mode is applied in a second multi-display environment, according to an embodiment of the disclosure;

FIGS. 7A and 7B are views illustrating a screen of a display device according to a movement of an execution screen when a display extension mode is applied in a second multi-display environment, according to an embodiment of the disclosure;

FIGS. 8A and 8B are views illustrating a screen of a display device according to a display layout when a display extension mode is applied in a second multi-display environment according to an embodiment of the disclosure;

FIG. 9 is a signal flowchart illustrating a procedure in which an electronic device controls a display device in a third multi-display environment, according to an embodiment of the disclosure;

FIGS. 10A and 10B are views illustrating a screen of a display device when a screen ratio of an image is equal to a screen ratio of a display when a display extension mode is applied in a third multi-display environment, according to an embodiment of the disclosure;

FIGS. 11A and 11B are views illustrating a screen of a display device in case that a screen ratio of an image is larger than a screen ratio of a display when a display extension mode is applied in a third multi-display environment, according to an embodiment of the disclosure; and

FIGS. 12A and 12B are views illustrating a screen of a display device in case that a screen ratio of an image is smaller than a screen ratio of a display when a display extension mode is applied in a third multi-display environment, according to an embodiment of the disclosure.

### MODE FOR THE INVENTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

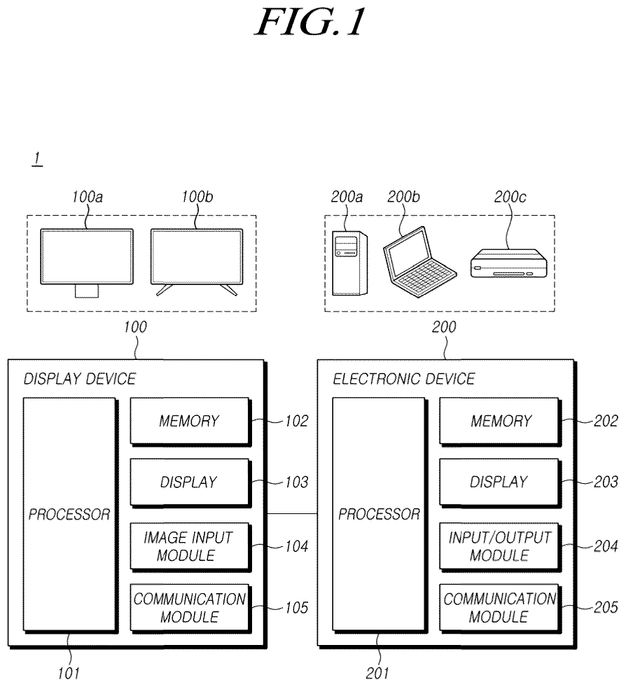

FIG. 1 is a view illustrating a display system including a plurality of display devices according to an embodiment of the disclosure.

According to an embodiment, a display system 1 may include a plurality of display devices 100 and/or an electronic device 200. Each device in the display system 1 may communicate with each other indirectly through a network (e.g., a wired or wireless network), or may directly communicate with each other.

According to an embodiment, the display device 100 may include at least one processor 101, memory 102, a display 103, an image input module 104, and/or a communication module 105. According to an embodiment, at least one (e.g., the communication module 105) of the components of the display device 100 may be omitted, or one or more other components (e.g., an input/output module) may be added. According to an embodiment, some of the components of the display device 100 may be integrated into one component.

According to an embodiment, the display device 100 may perform various computing functions (e.g., viewing an image) and may include a device capable of performing wired communication or wireless communication with a peripheral electronic device 200 or a server. The display device 100 may be, e.g., an electronic device (e.g., a monitor or a TV) including a display such as a three-dimensional (3D) display device 100a or a two-dimensional (2D) display device 100b, but the disclosure is not limited thereto. The display device 100 may include various types of electronic devices without limitation to the above-described contents.

According to an embodiment, the 3D display device 100a may support a 3D display (e.g., glasses-free 3D display). The 3D display device 100a may provide a 3D effect using a designated 3D display technology (e.g., a light field display technology). The light field display technology may be, e.g., a technology that provides a more natural and immersive 3D experience by simultaneously expressing the direction and intensity of light. Unlike general 3D display technology, this technology may provide a natural three-dimensional effect at various angles and viewpoints, rather than providing a three-dimensional effect only at a specific viewpoint.

According to an embodiment, the 3D display device 100a may include a configuration (e.g., a hardware configuration and/or a software configuration) for providing a 3D display. For example, a 3D display device 100a may include a multilayer display and/or lens array (e.g., an array of micro lenses or lenticular lenses) to provide a 3D display using light field display technology.

According to an embodiment, the 3D display device 100a may display a 3D image based on image data in a 3D format. The image data in the 3D format may be, e.g., image data in side-by-side format. The side-by-side format is one of the 3D formats, and may be a method of implementing a 3D effect by disposing two images left and right. This format is used to store or play 3D images, and to represent the 3D image, two images captured at the respective viewpoints of the left eye and the right eye are placed side by side and are processed by the 3D display device in an appropriate manner to appear in 3D.

According to an embodiment, the 2D display device 100b may support a 2D display. According to an embodiment, the 2D display device 100a may include a configuration (e.g., a hardware configuration and/or a software configuration) for providing a 2D display. The configuration for providing a 2D display may be at least partially different from the configuration for providing a 3D display.

According to an embodiment, the 3D display device 100a may support a 2D display together with a 3D display. In case that the 3D display device 100a supports both a 3D display and a 2D display, the 3D display device 100a may include both a configuration for a 3D display and a configuration for a 2D display. In this case, the 3D display device 100a may display a 2D image or a 3D image using an appropriate configuration (e.g., a hardware configuration) according to the display mode (e.g., 2D display mode or 3D display mode).

According to an embodiment, the at least one processor 101 may execute an operation or data processing related to control and/or communication of at least one other component of the display device 100 by executing at least one instruction stored in the memory 102. The processor 101 may include at least one processing circuit that executes instructions stored in the memory 102.

According to an embodiment, the at least one processor 101 may include various processing circuits and/or multiple processors. One or more of the at least one processor 101 may be configured to individually and/or collectively perform various functions described in the disclosure. In the disclosure, when it is described that “processor”, “at least one processor”, and “one or more processors” are configured to perform various functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 101 may include, e.g., a combination of processors performing various functions cited/initiated in a distributed manner. The at least one processor 101 may execute program instructions to achieve or perform various functions.

According to an embodiment, the at least one processor 101 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

According to an embodiment, the at least one processor 101 may execute, e.g., software to control at least one other component (e.g., a hardware or software component) of the display device 100 connected with the processor 101 and may process or compute various data. According to an embodiment, as at least part of the data processing or computation, the processor 101 may store a command or data received from another component onto a volatile memory, process the command or the data stored in the volatile memory, and store resulting data in a non-volatile memory. According to an embodiment, the processor 101 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121. For example, when the display device 100 includes the main processor and the auxiliary processor, the auxiliary processor may be configured to use lower power than the main processor or to be specified for a designated function. The auxiliary processor may be implemented separately from or as part of the main processor.

According to an embodiment, the processor 101 may obtain image frame data from at least one of the memory 102, the image input module 104, or the communication module 105. The processor 101 may receive image frame data from at least one of the memory 102, the display 103, the image input module 104, or the communication module 105. The image frame data may include data regarding a frame constituting an image. For example, the image frame data may be identified from the memory 102 (e.g., an image recorded and stored). For example, the image frame data may include data obtained from the communication module 105 or the image input module 104 (e.g., real-time streaming image).

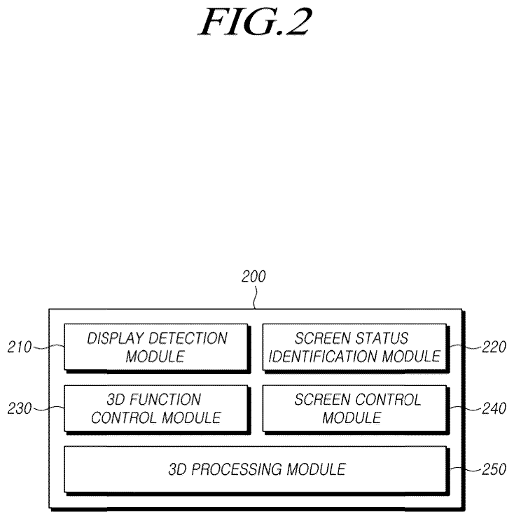

According to an embodiment, the memory 102 is a storage medium used by the display device 100 and may store data, such as at least one instruction or configuration information corresponding to at least one program. The program may include an operating system (OS) program and various application programs. The instructions stored in the memory 102 may, when executed by at least one processor 101, cause the display device 100 to perform at least one operation (e.g., at least one of the operations described below in connection with FIGS. 2 to 12).

According to an embodiment, the storage unit 102 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the display 103 may perform functions for outputting information in the form of numbers, characters, images, and/or graphics. The display 103 may include at least one hardware module for output. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 103 may display a screen corresponding to data received from the processor 101. The display 103 may be referred to by other terms having a technical meaning equivalent thereto. “Screen” may include an image displayed on the display of the electronic device. The image may be referred to by a term such as a frame. Various types of objects such as icons, texts, photos, videos, widgets, and the like may be displayed on the screen.

According to an embodiment, the image input module 104 may receive images and image information through a tuner, an input/output module, or the communication module 105. The image input module 104 may include at least one of the tuner and the input/output module. The tuner may tune and select only the frequency of the broadcast channel to be received by the display device 100 among many radio components, by amplifying, mixing, and resonating the broadcast signals wiredly/wirelessly received. The broadcast signal may include video, audio, and additional data (e.g., electronic program guide (EPG)). The tuner may receive real-time broadcast channels (or real-time viewing images) from various broadcast sources, such as terrestrial broadcasts, cable broadcasts, satellite broadcasts, Internet broadcasts, and the like. The tuner may be implemented integrally with the display device 100 or may be implemented as a separate tuner electrically connected to the display device 100. The input/output module may include at least one of a high definition multimedia interface (HDMI) input port, a component input jack, a PC input port, and a USB input jack capable of receiving an image and image information from an external device of the display device 100 under the control of the processor 101. It is obvious to one of ordinary skill in the art that the input/output module may be added, deleted, and/or changed according to the performance and structure of the display device 100.

According to an embodiment, the communication module 105 may include at least one communication circuitry and provide a wired/wireless communication interface that enables communication with an external device. The communication module 105 may include at least one of a wired Ethernet, a wireless LAN communication module, and a short-range communication module. The wireless LAN communication unit may include, e.g., Wi-Fi, and may support the wireless LAN standard (IEEE802.11x) of the institute of electrical and electronics engineers (IEEE). The wireless LAN communication module 105 may be wirelessly connected to an access point (AP) under the control of the processor 101. An AP may include a device for connecting devices by related standards using Wi-Fi in a computer network. The short-range communication unit may perform short-range communication wirelessly with an external device under the control of the processor 101. Short-range communication may include Bluetooth, Bluetooth low energy, infrared data association (IrDA), ultra-wideband (UWB), and near-field communication (NFC). The external device may include a server device and a mobile terminal (e.g., phone, tablet, etc.) providing, e.g., a video service.

According to an embodiment, the electronic device 200 may be directly connected to a plurality of display devices 100, control settings (e.g., multi-display settings) of the plurality of display devices 100, and provide data of an image (e.g., a 2D image or a 3D image) displayed on the screen of the display device 100 to the display device 100. The electronic device 200 may be an electronic device such as a desktop computer 200a, a laptop computer 200b, a device 200c (e.g., Samsung™ one connect (OC) box) that supports various connections between the display device 100 and an external device, but is not limited thereto. The electronic device 200 may be various types of electronic devices without being limited to the above examples. For example, the electronic device 200 may be an electronic device such as a smartphone, a tablet computer, or a server.

According to an embodiment, the electronic device 200 may include at least one processor 201, memory 202, a display 204, an input/output module 204, and/or a communication module 205. According to an embodiment, at least one (e.g., the display 203) of the components of the electronic device 200 may be omitted, or one or more other components (e.g., interface, a connecting terminal) may be added. According to an embodiment, the interface may support one or more designated protocols that may be used for the electronic device 200 to be directly (e.g., wiredly) or wirelessly connected to an external electronic device (e.g., the display device 100). According to an embodiment, the interface may include, e.g., a high definition multimedia interface (HDMI), a universal serial bus (USB) interface, a secure digital (SD) card interface, or an audio interface. According to an embodiment, the connecting terminal may include a connector via which the electronic device 200 may be physically connected with the external electronic device (e.g., the display device 200). According to an embodiment, the connecting terminal may include, for example, a HDMI connector, a USB connector, a SD card connector, or an audio connector (e.g., a headphone connector).

According to an embodiment, the at least one processor 201 may include at least one processing circuit that executes instructions stored in the memory 202. According to an embodiment, the at least one processor 201 may include various processing circuits and/or multiple processors. One or more of the at least one processor 201 may be configured to individually and/or collectively perform various functions described in the disclosure. In the disclosure, when it is described that “processor”, “at least one processor”, and “one or more processors” are configured to perform various functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 201 may include, e.g., a combination of processors performing various functions cited/initiated in a distributed manner. The at least one processor 201 may execute program instructions to achieve or perform various functions.

According to an embodiment, the processor 201 may execute, e.g., software (e.g., a program) to control at least one other component (e.g., a hardware or software component) of the electronic device 200 connected with the processor 201 and may process or compute various data. According to an embodiment, as at least part of the data processing or computation, the processor 201 may store a command or data received from another component onto a volatile memory, process the command or the data stored in the volatile memory, and store resulting data in a non-volatile memory. According to an embodiment, the processor 201 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 200 includes the main processor and the auxiliary processor, the auxiliary processor may be configured to use lower power than the main processor or to be specified for a designated function. The auxiliary processor may be implemented separately from, or as part of, the main processor.

According to an embodiment, the auxiliary processor may control at least some of functions or states related to at least one component of the electronic device 200, instead of the main processor while the main processor is in an inactive (e.g., sleep) state or along with the main processor while the main processor is an active state (e.g., executing an application). The auxiliary processor (e.g., an image signal processor or a communication processor) may be implemented as part of another component functionally related to the auxiliary processor 123. According to an embodiment, the auxiliary processor (e.g., the neural processing unit) may include a hardware structure specified for artificial intelligence model processing. The artificial intelligence model may be generated via machine learning. Such learning may be performed, e.g., by the electronic device 200 where the artificial intelligence is performed or via a separate server. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

According to an embodiment, the memory 202 may store various data used by at least one component (e.g., the processor 201) of the electronic device 200. The data may include, e.g., input data or output data for software (e.g., program) and related commands. The memory 202 may include volatile memory or nonvolatile memory. The instructions stored in the memory 202 may, when executed by at least one processor 201, cause the electronic device 200 to perform at least one operation (e.g., at least one of the operations described below in connection with FIGS. 2 to 12B). According to an embodiment, the program may be stored, as software, in the memory 202 and may include, e.g., an operating system (OS), middleware, or an application.

According to an embodiment, the input/output module 204 may include an input module and an output module (e.g., a sound output module, an audio module). The input module may receive a command or data to be used by other component (e.g., the processor 201) of the electronic device 200, from the outside (e.g., a user) of the electronic device 200. The input module may include, e.g., a microphone, a mouse, a keyboard, a key (e.g., a button), or a digital pen (e.g., a stylus pen). The sound output module may output sound signals to the outside of the electronic device 200. The sound output module may include, e.g., a speaker or a receiver. The speaker may be used for general purposes, such as playing multimedia or playing record. The receiver may be used for receiving incoming calls. According to an embodiment, the receiver may be implemented as separate from, or as part of the speaker. The audio module may convert a sound into an electrical signal and vice versa. According to an embodiment, the audio module may obtain the sound via the input module, or output the sound via the sound output module or an external electronic device (e.g., a speaker or headphone) directly or wirelessly connected to the electronic device 200.

According to an embodiment, the display 203 may visually provide information to the outside (e.g., the user) of the electronic device 200. The display 200 may include, for example, a display, a hologram device, or a projector and control circuitry to control a corresponding one of the display, hologram device, and projector. According to an embodiment, the display 200 may include a touch sensor configured to detect a touch, or a pressure sensor configured to measure the intensity of a force generated by the touch.

According to an embodiment, the communication module 205 may include at least one communication circuitry and support establishing a direct (e.g., wired) communication channel or a wireless communication channel between the electronic device 200 and the external electronic device (e.g., the plurality of display devices 100 or a server) and performing communication via the established communication channel. The communication module 205 may include one or more communication processors that are operable independently from the processor 201 (e.g., the application processor (AP)) and supports a direct (e.g., wired) communication or a wireless communication. According to an embodiment, the communication module 205 may include a wireless communication module (e.g., a cellular communication module, a short-range communication module, or a global navigation satellite system (GNSS) communication module) or a wired communication module (e.g., a local area network (LAN) communication module or a power line communication (PLC) module). A corresponding one of these communication modules may communicate with the external electronic device via a network (e.g., a short-range communication network, such as Bluetooth™, wireless-fidelity (Wi-Fi) direct, or infrared data association (IrDA) or a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

FIG. 2 illustrates a configuration of an electronic device for controlling a multi-display including a 3D display device according to an embodiment of the disclosure.

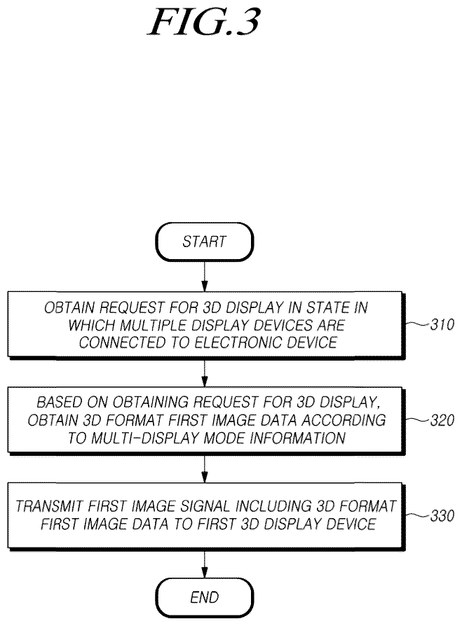

FIG. 3 is a flowchart illustrating a method of controlling a multi-display including a 3D display device by an electronic device according to an embodiment of the disclosure.

Referring to FIG. 2, an electronic device (e.g., the electronic device 200 of FIG. 1) may include at least one module for supporting a display (e.g., a 3D display). The at least one module may include, e.g., a display detection module 210, a screen status identification module 220, a 3D function control module 230, a screen control module 240, and/or a 3D processing module 250. At least one module may be implemented by the memory (e.g., the memory 202 of FIG. 1) and/or at least one processor (e.g., the processor 201 of FIG. 1) of the electronic device 200. For example, at least one module is configuring as instructions stored in memory, which may, when executed individually and/or collectively by at least one processor, cause the electronic device to perform at least one operation related to at least one module.

According to an embodiment, the display detection module 210 may identify at least one display device connected to the electronic device 200. According to an embodiment, the display detection module 210 may identify whether at least one display device connected to the electronic device 200 is a 3D display device (e.g., the 3D display device 100a of FIG. 1) or a 2D display device (e.g., the display device 100b of FIG. 1). For example, based on a display device being connected to the electronic device 200, the display detection module 210 may identify whether the display device is a 3D display device or a 2D display device using the device identifier (e.g., ID) of the display device. Through this method, the display detection module 210 may detect whether a single 3D display device is connected to the electronic device 200, a 3D display device is connected together with a 2D display device, or a 3D display device is connected together with another 3D display device.

According to an embodiment, the screen status identification module 220 may identify a screen status of the display device. For example, the screen status identification module 220 may identify the image or content that is currently output or displayed on the display device (e.g., 3D display device) and support the 3D processing module 250 to perform processing (e.g., conversion) for displaying 3D images if necessary. According to an embodiment, the screen status identification module 220 may identify a screen ratio and/or a multi-display layout state of an image or content to move an execution screen (e.g., a reproduction screen) of the image or content or provide information about whether to display a 3D image on the display device. The information may include, e.g., information informing whether the corresponding image or content may be displayed on the 3D display.

According to an embodiment, the 3D function control module 230 may control at least one function related to the 3D display. For example, in case that the 3D display device requires display of a 3D image, the 3D function control module 230 may convert the configuration (e.g., a hardware component) of the 3D display device into a suitable configuration for 3D display. According to an embodiment, the 3D function control module 230 may drive rendering software for 3D display.

According to an embodiment, the screen control module 240 may control a screen of the display device. For example, in case that the 3D display device and the 2D display device are connected together, the screen control module 240 may control a 3D image to be displayed only on the 3D display device based on the 3D display request being obtained.

According to an embodiment, the 3D processing module 250 may perform processing (e.g., image processing, format conversion processing) for the 3D display. For example, the 3D processing module 250 may obtain image data in a 3D format (e.g., a side-by-side format). For example, the 3D processing module 250 may convert 2D-format image data into 3D-format image data. For example, the 3D processing module 250 may convert 3D-format image data into 2D-format image data.

Referring to FIG. 3, according to an embodiment, in operation 310, the electronic device 200 may obtain a request for 3D display in a state in which the plurality of display devices are connected to the electronic device. In the disclosure, a request for 3D display may be abbreviated as a 3D display request.

According to an embodiment, the electronic device 200 may identify that the plurality of display devices are connected to the electronic device using the display detection module 210, and identify the type of the connected display device (e.g., the 3D display device or the 3D display device). According to an embodiment, the plurality of display devices may include at least one 3D display device (e.g., the 3D display device 100a of FIG. 1) supporting the 3D display. For example, the plurality of display devices may include a first 3D display device supporting the 3D display. According to an embodiment, the plurality of display devices may be configured as a multi-display. In the disclosure, a multi-display environment composed of only a plurality of 2D display devices may be referred to as a first multi-display environment (or a 2D multi-display environment), a multi-display environment composed of one 3D display device and at least one 2D display device may be referred to as a second multi-display environment (or a first 3D multi-display environment), and a multi-display environment including a plurality of 3D displays may be referred to as a third multi-display environment (or a second 3D multi-display environment).

According to an embodiment, the request for 3D display may be obtained based on a user input, or may be obtained based on identifying that a designated condition is met. For example, the electronic device may identify that a request for 3D display is obtained in response to receiving a user input for executing or activating the 3D display (e.g., pressing a designated physical button or a UI button included in the execution screen). The designated condition may be met, e.g., in case that an application (e.g., a 3D game application) requiring activation of the 3D display is executed, but the disclosure is not limited thereto.

According to an embodiment, in operation 320, the electronic device 200 may obtain the first image data of the 3D format (e.g., a side-by-side format) according to the multi-display mode information based on obtaining the request for 3D display. According to an embodiment, in operation 330, the electronic device 200 may transmit a first image signal including first image data in the 3D format to the first 3D display device. Operations 320 and 330 may be performed using the screen status identification module 220, the 3D function control module 230, the screen control module 240, and/or the 3D processing module 250.

According to an embodiment, the multi-display mode information may indicate the multi-display mode. The multi-display mode may be, e.g., one of a display duplication mode or a display extension mode.

According to an embodiment, the display duplication mode may be a mode in which content (e.g., an image) displayed on the screen of one display device (e.g., a main display device) is duplicated and displayed on the screen of another display device configured as a multi-display. For example, in the display duplication mode, images of the same content may be displayed on the plurality of display devices configured as a multi-display. Compared to the display extension mode, the display duplication mode has the advantage of being simple to set up and being able to show the same content (e.g., the same frame) through the plurality of screens. However, in the display duplication mode, the resolution of other display devices may be affected according to the resolution of the main display device.

According to an embodiment, the display extension mode may be a mode in which all of the screens of the plurality of display devices configured as a multi-display are recognized as one wide screen, and the screen of each display device is recognized as portion of one wide screen. In the display extension mode, a portion of the image of the same content may be divided and displayed on the screen of each display device. For example, a portion of an image with a screen ratio of 32:9, e.g., the left half and the right half of the image, may be displayed on the screen of each display device with a screen ratio of 16:9. In the display extension mode, execution screens of different contents may be displayed on the respective screens of the display devices, respectively. For example, the first execution screen of the first application (e.g., word processor application) may be displayed on the screen of the first display device, and the second execution screen of the second application (e.g., Internet application) may be displayed on the screen of the second display device. In the display extension mode, the execution screen displayed on the screen of one display device may be moved to the screen of another display device. For example, in the display extension mode, the execution screen displayed on the screen of one display device may be moved to the screen of another display device according to a user input (e.g., touch input, or mouse input). This display extension mode is suitable for multitasking tasks because it may provide an extended workspace to the user, and has the advantage that the setting (e.g., resolution setting) of each display device may be performed individually. However, the setting of the display extension mode may be more complicated than the display duplication mode.

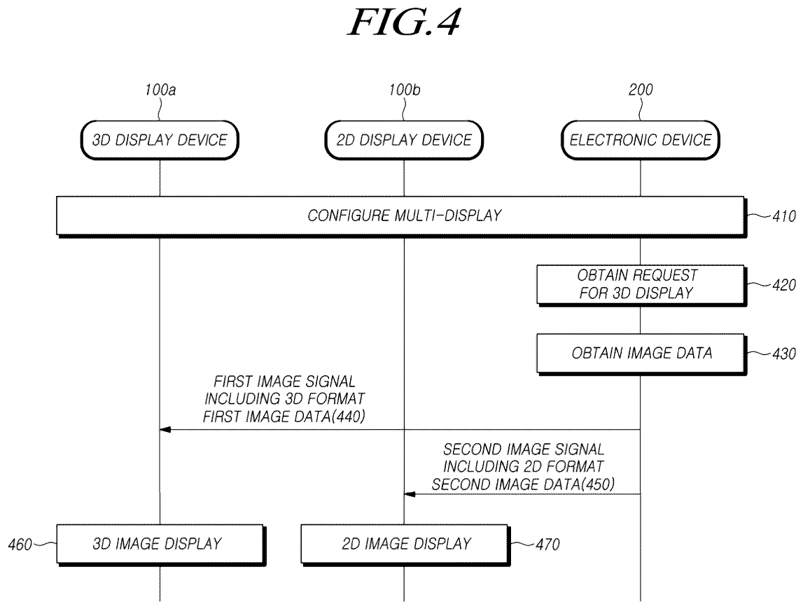

According to an embodiment, the plurality of display devices may further include the 2D display device (e.g., the 2D display device 100b of FIG. 1) supporting a 2D display. For example, the plurality of display devices configured as a multi-display may include a first 3D display device and a 2D display device. Accordingly, the second multi-display environment may be provided. Various examples of display operations in the second multi-display environment are described below with reference to FIGS. 4 to 8B.

According to an embodiment, in case that the plurality of display devices include a first 3D display device and a 2D display device, and the multi-display mode is in the display duplication mode, the electronic device 200 may obtain image data including a first image data of 3D format (a 3D format first image data) and a second image data of 2D format (a 2D format second image data), transmit a first image signal including the 3D format first image data to the first 3D display device, and transmit a second image signal including the 2D format second image data to the 2D display device. According to an embodiment, the 3D format first image data and the 2D format second image data may be image data for the same content (e.g., game image content). The first 3D display device may display a 3D image based on the first image data, and the 2D display device may display a 2D image based on the second image data. As described above, in the second multi-display environment, in case that the display duplication mode is applied, a 3D image and a 2D image for the same content may be simultaneously displayed through each display device. On the other hand, in case that the display duplication mode is applied in the first multi-display environment, completely identical 2D images for the same content are displayed simultaneously through each display device. On the other hand, as described above, in case that the display duplication mode is applied in the second multi-display environment, since the 3D image and the 2D image for the same content are simultaneously displayed through each display device, the user may compare the reproduction of the 3D image and the 2D image for the same content (e.g., the same frame) in real-time. This may provide a new user experience to the user. Accordingly, the user may clearly identify the 3D effect of the 3D display device.

According to an embodiment, in case that the plurality of display devices include a first 3D display device and the 2D display device, and the multi-display mode is the display extension mode, the electronic device 200 may obtain the 3D format first image data by converting the 2D format image data corresponding to the 2D image (or the first execution screen) into the 3D format first image data based on identifying that at least a portion (e.g., more than half of the first execution screen) of the first execution screen including the 2D image of the 2D display device is moved to the first 3D display device. The movement of the first execution screen may be identified through, e.g., the screen status identification module 220. The electronic device 200 may transmit a first image signal including first image data to the first 3D display device. The first 3D display device may display the 3D image based on the first image data. For example, the first 3D display device may display a second execution screen including a 3D image on the screen (e.g., the entire screen) of the first 3D display device based on the first image data. As such, in case that the display extension mode is applied in the second multi-display environment and at least a portion of the first execution screen including the 2D image displayed in the 2D display device is moved to the 3D display device, the second execution screen including the 3D image converted from the 2D image may be displayed on the entire screen of the 3D display device. On the other hand, in case that the display extension mode is applied and at least a portion of the first execution screen including the 2D image displayed on one 2D display device is moved to another 2D display device in the first multi-display environment, the same 2D image is simply moved to the 2D display device and displayed. On the other hand, as described above, in the second multi-display environment, in case that the display extension mode is applied and at least a portion of the execution screen including the 2D image displayed on the 2D display device is moved to the 3D display device, the 2D image may be naturally converted into a 3D image and provided to the user through the entire screen of the 3D display device according to the movement of the execution screen. This may provide a new user experience to the user. Accordingly, the user may naturally convert the 2D image and the 3D image according to the movement of the execution screen between the 2D display device and the 3D display device.

According to an embodiment, the 3D display device (e.g., the first 3D display device and/or the second display device) may be a display device that supports both the 3D display and the 2D display. In this case, the 3D display device may operate in the 2D display mode or the 3D display mode according to the display mode information. According to an embodiment, the display mode information may indicate a display mode, and the display mode may be one of the 2D display mode or the 3D display mode. This display mode information may be used for switching the display mode in the 3D display device.

According to an embodiment, the display mode information may be set by the electronic device 200. For example, the electronic device 200 may set display mode information to the 3D display mode based on the 3D display request being obtained (e.g., at a point in time when the 3D display request is obtained). According to an embodiment, the electronic device 200 may transmit the set display mode information to the 3D display device (e.g., the first 3D display device and/or the second display device). Based on identifying that display mode information indicating that the display mode is the 3D display mode is received from the electronic device 200 while the 3D display device operates in the 2D display mode, the display mode may be switched from the 2D display mode to the 3D display mode. Through this method, the display mode of the 3D display device may be controlled by the electronic device 200.

According to an embodiment, the display mode information may be included in the first image signal including the 3D format first image data. In this case, the first 3D display device may set the display mode to the 3D display mode based on the display mode information included in the first image signal and display the 3D image based on the first image data included in the first image signal. Through this method, compared to transmitting display mode information separately from image data, communication resources between electronic devices and 3D display devices may be efficiently utilized, and delay due to display mode switching may be decreased.

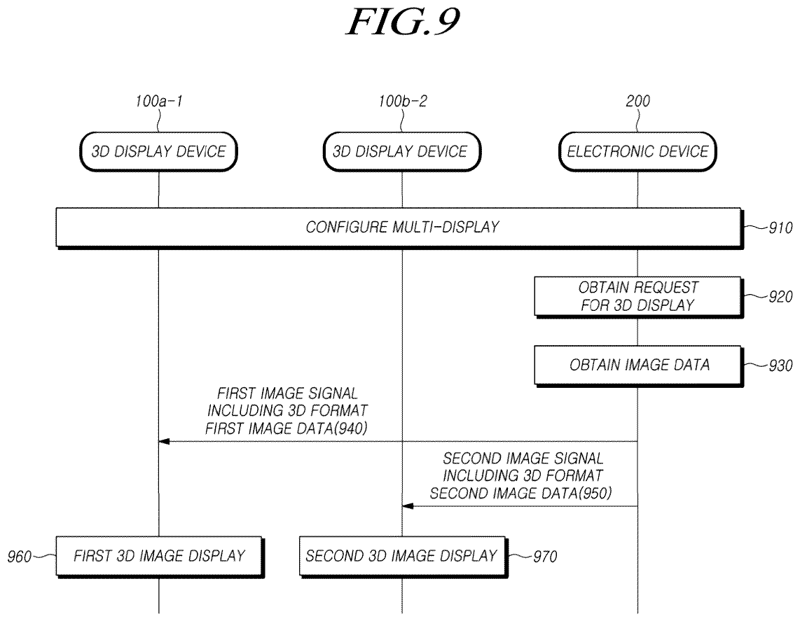

According to an embodiment, the plurality of display devices may further include a second 3D display device (e.g., the 3D display device 100a of FIG. 1) supporting the 3D display. For example, the plurality of display devices configured as a multi-display may include the first 3D display device and the second 3D display device. Accordingly, the third multi-display environment may be provided. Various examples of display operations in the third multi-display environment are described below with reference to FIGS. 9 to 12B.

According to an embodiment, in case that the plurality of display devices include the first 3D display device and the second 3D display device, and the multi-display mode is the display extension mode (or the display duplication mode), the electronic device 200 may obtain 3D format image data (e.g., the first image data and/or the second image data) based on first screen ratio information about the screen ratio of the image (e.g., 2D image) and second screen ratio information about the screen ratio of at least one 3D display device (e.g., the first 3D display device and/or the second 3D display device) where the image is to be displayed.

According to an embodiment, in the third multi-display environment, in case that the screen ratio (e.g., 16:9) of the image is the same as the screen ratio (e.g., 16:9) of the 3D display device, and the multi-display mode is the display extension mode (or, display duplication mode), the electronic device 200 may obtain 3D format image data that allows the 3D image converted from the 2D image to be displayed on at least one (e.g., one full screen) of the first 3D display device or the second 3D display device. In case that the multi-display mode is the display extension mode, the electronic device 200 may transmit image data to one of the first 3D display device and the second 3D display device. In case that the multi-display mode is the display duplication mode, the electronic device 200 may transmit the same image data to both the first 3D display device and the second 3D display device. As described above, in case that the screen ratio of the 2D image and the screen ratio of the 3D display device are the same in the third multi-display environment, the electronic device 200 may change only the image format from the 2D format to the 3D format without adjusting the screen ratio of the image and transmit it to the 3D display device. The 3D display device receiving the 3D format image data may display the 3D image on the entire screen based on the image data. Since the 3D image displayed in this way is a 3D image converted from the 2D image without adjusting the screen ratio of the image, the quality of the image may not deteriorate. Accordingly, the electronic device 200 may naturally convert a 2D image into a 3D image and provide the 3D image without deterioration of the quality of the image. According to an embodiment, in case that the multi-display mode is the display extension mode, the execution screen of the 3D image displayed on one 3D display device may be moved to another 3D display device. Accordingly, the 3D image may be displayed on the 3D display device desired by the user. According to an embodiment, in case that the multi-display mode is the display duplication mode, the execution screens of the same 3D image may be simultaneously displayed on each 3D display device. Accordingly, the user may compare the 3D performance of each 3D display device in real-time.

According to an embodiment, in the third multi-display environment, in case that the screen ratio (e.g., 32:9) of the image is larger than the screen ratio (e.g., 16:9) of the 3D display device, and the multi-display mode is the display extension mode, the electronic device 200 may obtain 3D format image data that allows the 3D image to be displayed on the first 3D display device and the second 3D display device. For example, the electronic device may obtain 3D-format image data including 3D-format first partial image data corresponding to the first portion of the image (e.g., the left half of the 2D image) and second 3D-format second partial image data corresponding to the second portion of the image (e.g., the right half of the 2D image). According to an embodiment, the first partial image data may be used to display the first 3D image corresponding to the first portion of the image on the first 3D display device, and the second partial image data may be used to display the second 3D image corresponding to the second portion of the image on the second 3D display device. The electronic device may transmit the first image signal including the first partial image data to the first 3D display device and transmit the second image signal including the second partial image data to the second 3D display device. As such, in the third multi-display environment, in case that the screen ratio of the 2D image is larger than the screen ratio of the 3D display device, the electronic device 200 may process the 3D image converted from the 2D image into a plurality of 3D format partial image data to be displayed on the plurality of 3D display devices and transmit each partial image data to each 3D display device. Since the 3D image displayed in this way is a 3D image converted from the 2D image without adjusting the screen ratio of the image, the quality of the image does not deteriorate. Further, since the 3D image is displayed through the plurality of 3D display devices, it may provide a better 3D effect than the 2D multi-display environment in which the 3D image is displayed through one 3D display device.

According to an embodiment, in the third multi-display environment, in case that the screen ratio (e.g., 16:9) of the image is smaller than the screen ratio (e.g., 32:9) of the 3D display device, and the multi-display mode is the display extension mode (or display duplication mode), the electronic device 200 may obtain 3D format image data that allows the 3D image converted from the 2D image to be displayed on at least one (e.g., at least one full screen or partial screen) of the first 3D display device or the second 3D display device. In case that the multi-display mode is the display extension mode, the electronic device 200 may transmit image data to one of the first 3D display device and the second 3D display device. In case that the multi-display mode is the display duplication mode, the electronic device 200 may transmit the same image data to both the first 3D display device and the second 3D display device. As described above, in case that the screen ratio of the image is smaller than the screen ratio of the display, the electronic device 200 may adjust the screen ratio of the image and transmit it to the 3D display device. The 3D display device receiving the 3D format image data may display the 3D image on the entire screen based on the image data. Since the 3D image displayed in this way is an image in which the screen ratio of the image is adjusted (e.g., from 16:9 to 32:9), the quality of the image may deteriorate. According to an embodiment, the electronic device 200 may adjust the screen ratio of the image using a trained AI model (e.g., a generative AI model). Accordingly, quality deterioration due to adjustment of the screen ratio of the image may be decreased.

FIG. 4 is a signal flowchart illustrating a process in which the electronic device controls a display device in a second multi-display environment, according to an embodiment of the disclosure.

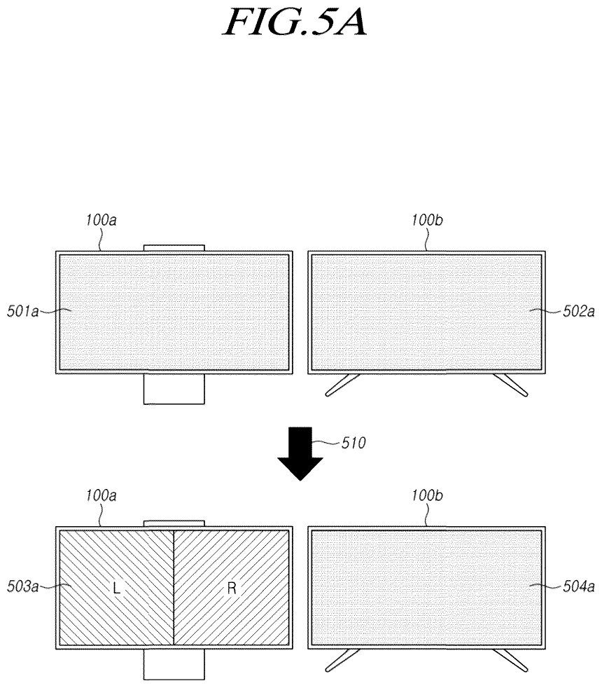

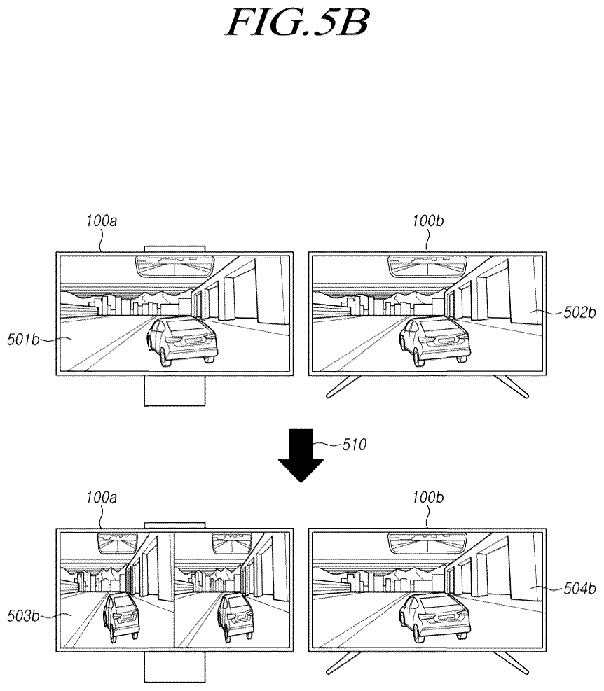

FIGS. 5A and 5B are views illustrating a screen of a display device when a display duplication mode is applied in a second multi-display environment, according to an embodiment of the disclosure.

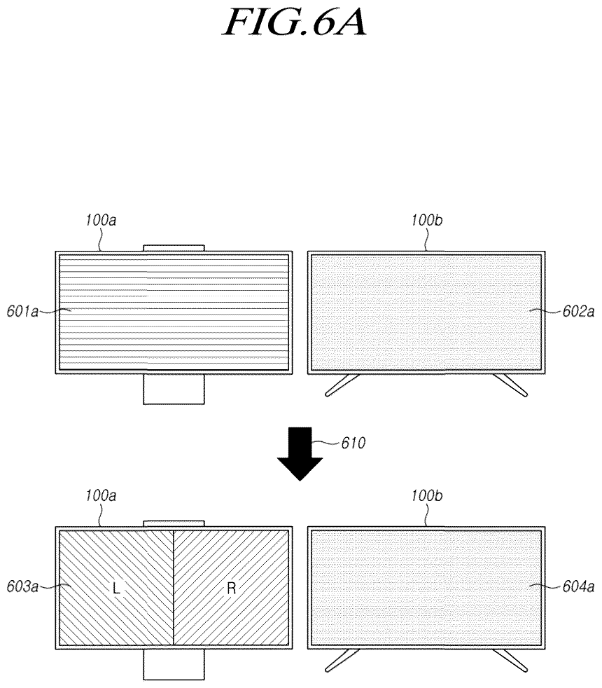

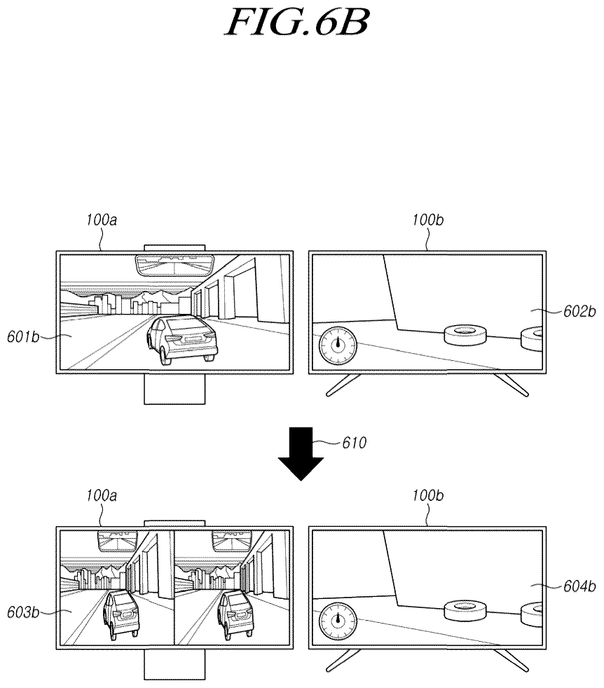

FIGS. 6A and 6B are views illustrating a screen of a display device when a display extension mode is applied in a second multi-display environment, according to an embodiment of the disclosure.

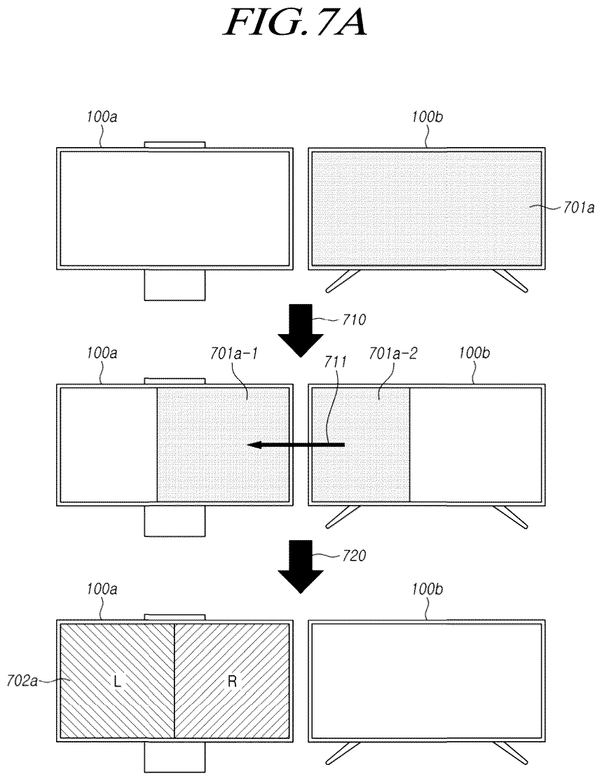

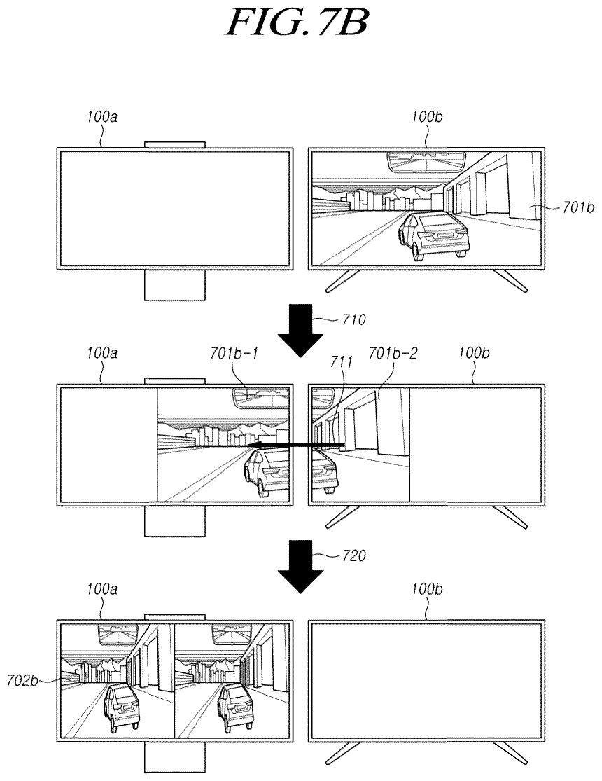

FIGS. 7A and 7B are views illustrating a screen of a display device according to a movement of an execution screen when a display extension mode is applied in a second multi-display environment, according to an embodiment of the disclosure.

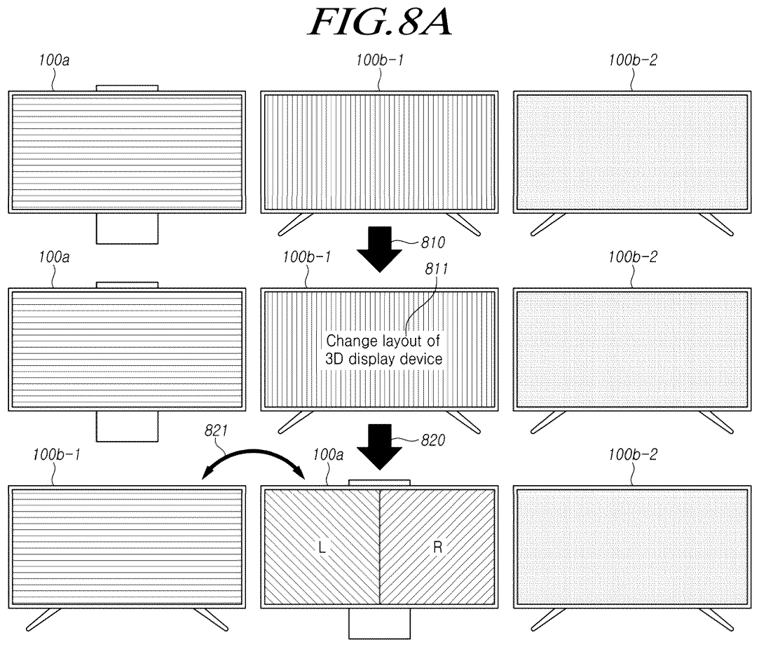

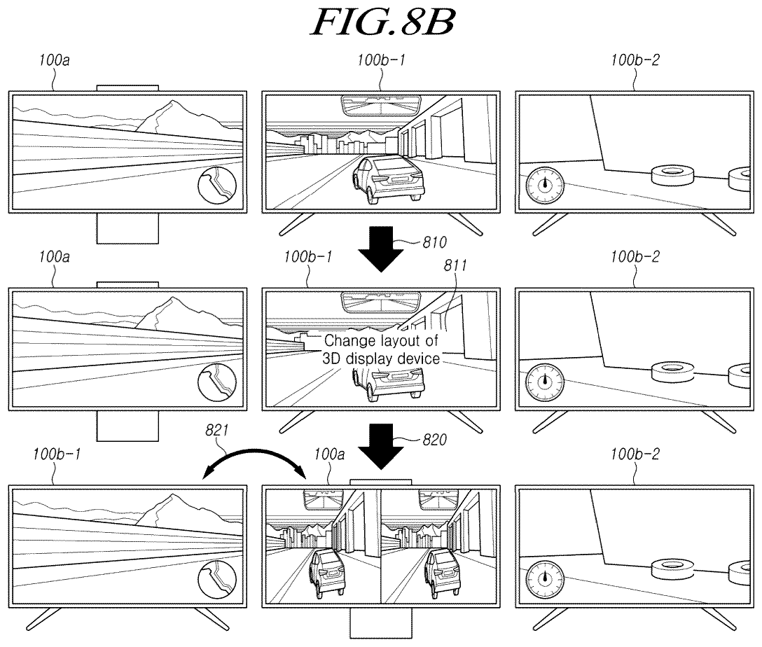

FIGS. 8A and 8B are views illustrating a screen of a display device according to a display layout when a display extension mode is applied in a second multi-display environment according to an embodiment of the disclosure.

According to an embodiment, in the embodiments of FIGS. 4 to 8B, it is assumed that the multi-display environment is the second multi-display environment constituted of one 3D display device and at least one 2D display device. Further, in the embodiments of FIGS. 4 to 8B, it is assumed that an image of content (e.g., game content) is displayed on at least one display device.

Referring to FIG. 4, according to an embodiment, in operation 410, the electronic device 200 may identify a 3D display device 100a and at least one 2D display device 100 b, and configure the 3D display device 100a and the at least one 2D display device 100b as a multi-display. Operation 410 may be performed using, e.g., the display detection module 210 of FIG. 2.

According to an embodiment, the electronic device 200 may configure the 3D display device 100a and the at least one 2D display device 100b as a multi-display in response to identifying that the 3D display device 100a and the at least one 2D display device 100b are connected to the electronic device 200 via wired connection (e.g., wired connection through an HDMI or USB-C type cable) or wireless connection (e.g., wireless connection through Wi-Fi or Wi-Fi Direct).

According to an embodiment, the electronic device 200 may set multi-display configuration information for configuring the multi-display. The multi-display configuration information may include, e.g., multi-display environment information, multi-display mode information, multi-display layout information, and/or multi-display resolution information. The multi-display environment information may indicate a multi-display environment. As described above, the multi-display environment may be one of a first multi-display environment, the second multi-display environment, or the third multi-display environment. As described above, the multi-display mode information may indicate the multi-display mode. The multi-display layout information may include layout information about the plurality of display devices configured as a multi-display. For example, the multi-display layout information may include information about the relative position of the 3D display device 100a with respect to at least one 2D display device 100b configured as a multi-display. The multi-display resolution information may include information about the resolution of each of the plurality of display devices configured as a multi-display. The resolutions of the plurality of display devices configured as a multi-display may be the same or different from each other.

According to an embodiment, in operation 420, the electronic device 200 may obtain a 3D display request in the second multi-display environment. Operation 420 may include, e.g., operation 310 of FIG. 3.

According to an embodiment, in operation 430, the electronic device 200 may obtain image data based on the 3D display request. Operation 430 may include, e.g., operation 320 of FIG. 3. The operation of obtaining image data may include, e.g., an operation of converting a 2D format image into a 3D format image.

According to an embodiment, the electronic device 200 may obtain image data based on at least one configuration information. The at least one configuration information may include, e.g., multi-display configuration information, content information, and/or display mode information, but the disclosure is not limited thereto. The content information may include information about content to be displayed on at least one (e.g., the 3D display device) of the plurality of display devices configured to a multi-display. The content information may include, e.g., information about the type of content (e.g., 2D, 3D content) and/or information about the screen ratio of the image corresponding to the content, but the disclosure is not limited thereto. The at least one configuration information may be obtained and/or used, e.g., the display detection module 210, the screen status identification module 220, the 3D function control module 230, and/or the screen control module 240.

According to an embodiment, the image data may include 3D format first image data and/or 2D format second image data.

According to an embodiment, in case that the multi-display mode is the display duplication mode in the second multi-display environment, the electronic device 200 may obtain image data including the 3D format first image data and the 2D format second image data. According to an embodiment, the 3D format first image data and the 2D format second image data may be image data for the same content (e.g., game image content). According to an embodiment, the operation of obtaining the 3D format first image data may include, e.g., an operation of converting the 2D format image data into the 3D format image data.

According to an embodiment, in case that the multi-display mode is the display extension mode in the second multi-display environment, the electronic device 200 may obtain the 3D format first image data by converting the 2D format image data into the 3D format first image data.

According to an embodiment, in case that the multi-display mode is the display extension mode in the second multi-display environment, the electronic device 200 may obtain the 3D format first image data by converting the 2D format image data corresponding to the 2D image (or first execution screen) into the 3D format first image data based on identifying that at least a portion (e.g., more than half of the first execution screen) of the first execution screen including the 2D image of the 2D display device is moved to the first 3D display device. The movement of the first execution screen may be identified through, e.g., the screen status identification module 220.

According to an embodiment, after the 3D display request is obtained, based on identifying that the 3D display device is not disposed at a designated position (e.g., center) in the entire display device configuration based on the multi-display layout information, the electronic device 200 may visually or audibly provide guidance information (e.g., the guidance information 811 of FIG. 8) to change the layout of the 3D display device without converting the 2D format image to the 3D format image. This is because in case that the 3D display device is not disposed at the center in the entire display device configuration but is disposed on the side, it may be unnecessary or inefficient to display the 3D image.

According to an embodiment, in operation 440, the electronic device 200 may transmit the first image signal including the 3D format first image data to the 3D display device 100a. Operation 440 may include, e.g., operation 330 of FIG. 3. According to an embodiment, in operation 460, the 3D display device 100a may display the 3D image based on the first image data. For example, the 3D display device 100a may display an execution screen (or reproduction screen) including the 3D image based on the first image data.

According to an embodiment, in operation 450, the electronic device 200 may transmit the second image signal including 2D format second image data to the 2D display device. According to an embodiment, in operation 470, the 2D display device 100b may display the 2D image based on the second image data. For example, the 2D display device 100b may display the execution screen (or reproduction screen) including the 2D image based on the second image data. According to an embodiment, operations 450 and 470 may be omitted.

According to an embodiment, in case that the multi-display mode is the display duplication mode, as illustrated in FIGS. 5A and 5B, the 3D display device 100a and the 2D display device 100b may simultaneously display the first execution screens 501a and 502b and the second execution screens 502a and 502b including duplicated 2D images of the same content. For example, as illustrated in FIG. 5B, the first execution screen 501b and the second execution screen 502b may include exactly the same 2D image at the viewpoint A or the time point A (e.g., scene A or frame A) of the same content (e.g., game content). After the 3D display request 510 is obtained, the 3D display device 100a may display the third execution screens 503a and 503b including the 3D image (e.g., the 3D image in side-by-side format), and the 2D display device 100b may display the fourth execution screens 504a and 504b including the 2D image. For example, as illustrated in FIG. 5B, the third execution screen 503b and the fourth execution screen 504b may include a 3D image and a 2D image at the viewpoint B or the time point B (e.g., scene B or frame B) of the same content (e.g., game content). As such, in case that the display duplication mode is applied in the second multi-display environment, the 3D image and the 2D image for the same content (e.g., image content) may be simultaneously displayed through each display device. In this case, the user may compare the reproduction of the 3D image and the reproduction of the 2D image for the same content in real-time. This may provide a new user experience to the user. Accordingly, the user may clearly identify the 3D effect of the 3D display device.

According to an embodiment, in case that the multi-display mode is the display extension mode, as illustrated in FIGS. 6A and 6B, the 3D display device 100a and the 2D display device 100b may simultaneously display the first execution screens 601a and 601b and the second execution screens 602a and 602b including different 2D images (e.g., different portions of the 2D image of the same content). For example, as illustrated in FIG. 6B, the first execution screen 601b and the second execution screen 602b may include a 2D image corresponding to the first image portion at the viewpoint A or the time point A (e.g., scene A or frame A) of the same content (e.g., game content) and a 2D image corresponding to the second image portion different from the first image portion. After the 3D display request 610 is obtained, the 3D display device 100a may display the third execution screens 603a and 603b including the 3D image (e.g., the 3D image in side-by-side format), and the 2D display device 100b may display the fourth execution screens 604a and 604b including the 2D image. For example, as illustrated in FIG. 6B, the third execution screen 603b and the fourth execution screen 604b may include a 3D image corresponding to the third image portion at the viewpoint B or the time point B (e.g., scene B or frame B) of the same content (e.g., game content) and a 2D image corresponding to the fourth image portion different from the third image portion. As such, in case that the display extension mode is applied in the second multi-display environment, the 2D image may be naturally converted into a 3D image and displayed on the screen of the 3D display device. This may provide a new user experience to the user. Through this method, the user may naturally convert the 2D image into the 3D image by providing the 3D display request to the electronic device 200.

According to an embodiment, in case that the multi-display mode is the display extension mode, as illustrated in FIGS. 7A and 7B, the 2D display device 100b may display the first execution screens 701a and 701b including the 2D image. For example, as illustrated in FIG. 7B, the first execution screen 701b may include the 2D image at the viewpoint A or the time point A (e.g., scene A or frame A) of the same content (e.g., game content). After the 3D display request 710 is obtained, it may be identified 711 that at least some portions 701a-1 and 701b-1 of the first execution screens 701a and 701b are moved to the screen of the 3D display device 100a. After identifying 720 that the movement of the first execution screens 701a and 701b meets a designated condition, the 3D display device 100a may display the second execution screens 702a and 702b including the 3D image (e.g., a 3D image in side-by-side format) converted from the 2D image on the entire screen of the 3D display device 100a. According to an embodiment, the designated condition may be met, e.g., in case that the size of the first portions 701a-1 and 701b-1 of the first execution screens 701a and 701b moved to the screen of the 3D display device 100a is larger than half the size of the entire screen of the 3D

display device 100a, or is larger than the size of the second portions 701a-1 and 701b-1 of the first execution screens 701a and 701b remaining on the screen of the 2D display device 100b. As illustrated in FIG. 7B, the second execution screen 702b may include the 3D image at the viewpoint B or the time point B (e.g., scene B or frame B) of image content (e.g., game content). As such, in case that the display extension mode is applied in the second multi-display environment and at least a portion of the first execution screen including the 2D image displayed on the 2D display device is moved to the 3D display device, the second execution screen including the 3D image converted from the 2D image may be displayed on the entire screen of the 3D display device. Through this method, the 2D image may be naturally converted into the 3D image according to the movement of the execution screen and provided to the user through the entire screen of the 3D display device. This may provide a new user experience to the user. Accordingly, the user may naturally convert the 2D image and the 3D image according to the movement of the execution screen between the 2D display device and the 3D display device.

According to an embodiment, in case that the multi-display mode is the display extension mode, as illustrated in FIGS. 8A and 8B, the 3D display device 100a, the first 2D display device 100b-1, and the second 2D display device 100b-1 may display different

execution screens, respectively. For example, as illustrated in FIG. 8B, the 3D display device 100a, the first 2D display device 100b-1, and the second 2D display device 100b-1 may each display different execution screens including different 2D image portions at the viewpoint A or the time point A (e.g., scene A or frame A) of the same content (e.g., game content). After the 3D display request 810 is obtained, at least one display device (e.g., the display device disposed at the center in the entire display device configuration) may display guidance information 811 to change the layout of the 3D display device 100a. According to an embodiment, after the 3D display request 810 is obtained, based on identifying that the 3D display device 100a is not disposed at the center in the entire display device configuration based on the multi-display layout information, the electronic device 200 may visually or audibly provide guidance information 811 without immediately converting the 2D image into the 3D image. This is because in case that the 3D display device 100a is not disposed at the center in the entire display device configuration but is disposed on the side, it may be unnecessary or inefficient to display the D image. After the guidance information 811 is provided, based on it is identified (820) that the 3D display device 100a is disposed at the center of the entire display device configuration according to the layout change 821 of the display device, the 3D display device 100a may display the execution screen including the 3D image (e.g., the 3D image in side-by-side format) converted from the 2D image on the screen (e.g., the full screen) of the 3D display device 100a. For example, as illustrated in FIG. 8B, the 3D image may include the 3D image at the viewpoint B or the time point B (e.g., scene B or frame B) of image content (e.g., game content). As such, even when the display extension mode is applied in the second multi-display environment and the 3D display request is obtained, if it is unnecessary or inefficient to display the 3D image, guidance information such as for changing the layout of the 3D display device may be provided to the user without immediately displaying the 3D image. Through this method, a 3D image may be provided only when the circumstance is changed so that it is necessary or efficient to display of a 3D image. Accordingly, a 3D image may be efficiently provided, and unnecessary waste of resources due to the provision of the 3D image may be prevented.

FIG. 9 is a signal flowchart illustrating a procedure in which an electronic device controls a display device in a third multi-display environment, according to an embodiment of the disclosure.

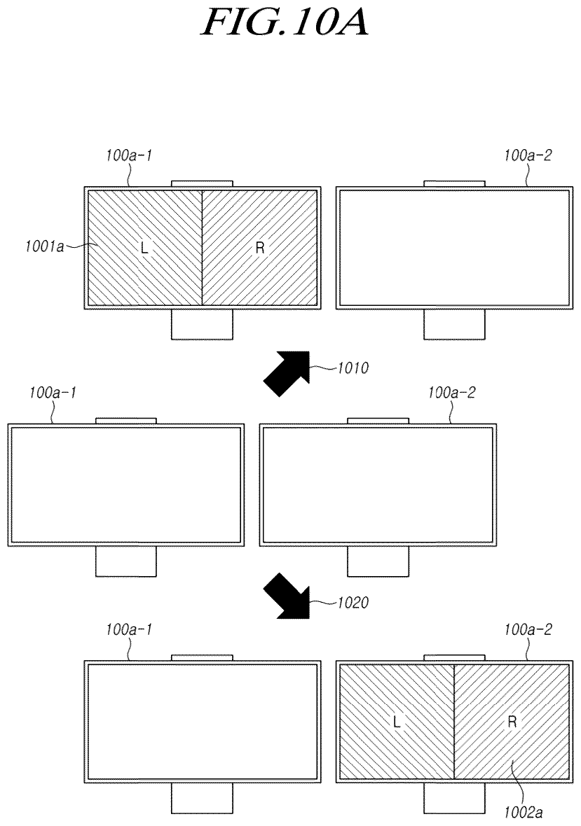

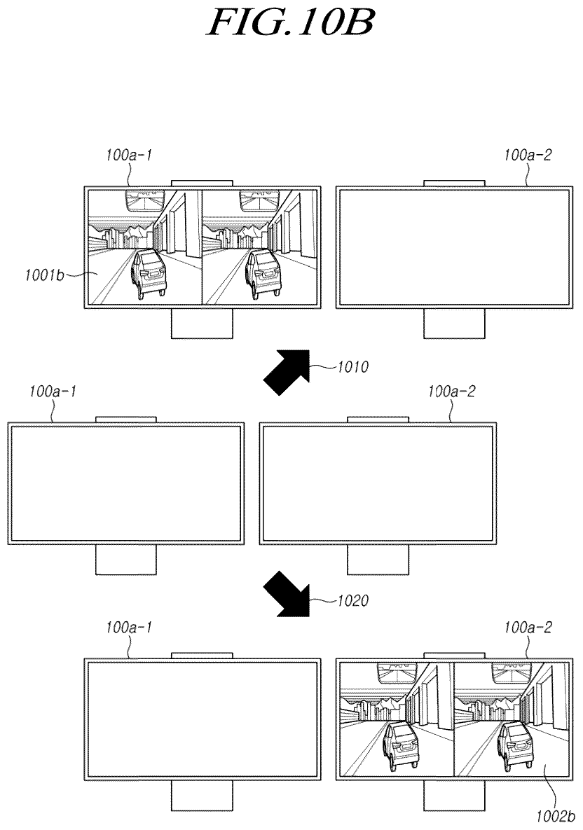

FIGS. 10A and 10B are views illustrating a screen of a display device when a screen ratio of an image is equal to a screen ratio of a display when a display extension mode is applied in a third multi-display environment, according to an embodiment of the disclosure.

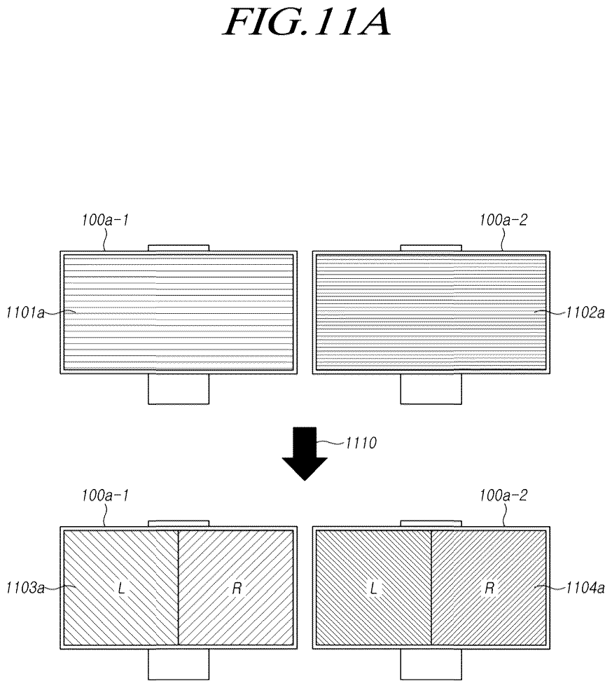

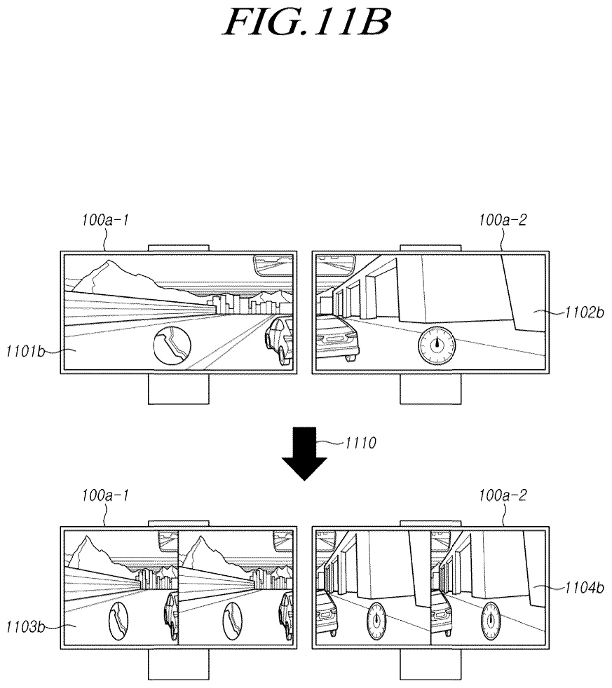

FIGS. 11A and 11B are views illustrating a screen of a display device when a screen ratio of an image is larger than a screen ratio of a display when a display extension mode is applied in a third multi-display environment, according to an embodiment of the disclosure.

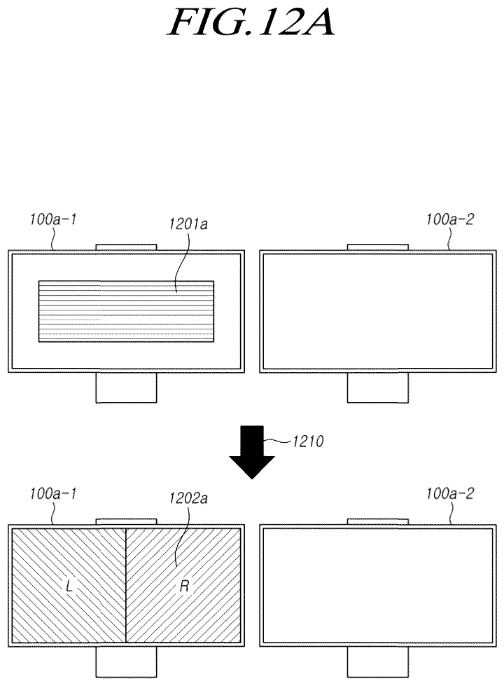

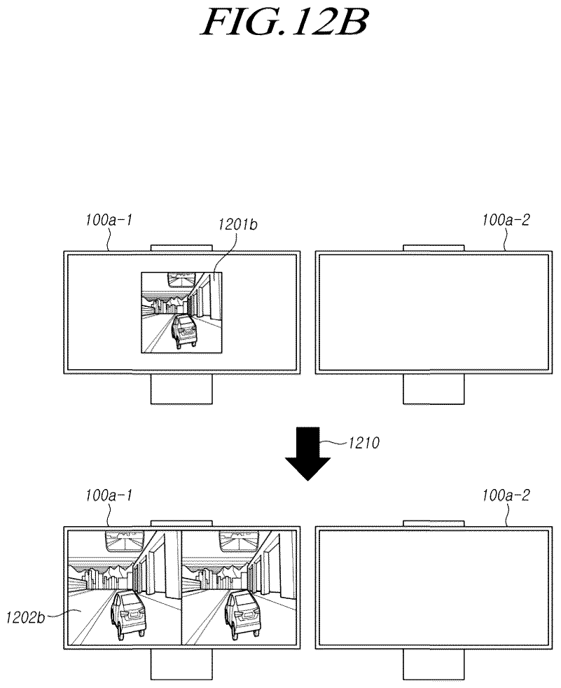

FIGS. 12A and 12B are views illustrating a screen of a display device when a screen ratio of an image is smaller than a screen ratio of a display when a display extension mode is applied in a third multi-display environment, according to an embodiment of the disclosure.

According to an embodiment, in the embodiments of FIGS. 9 to 12B, it is assumed that the multi-display environment is the third multi-display environment including a plurality of 3D display devices. Further, in the embodiments of FIGS. 9 to 12B, it is assumed that an image of content (e.g., game content) is displayed on at least one display device.

Referring to FIG. 9, according to an embodiment, in operation 910, the electronic device 200 may identify a first 3D display device 100a-1 and a second 3D display device 100a-2 and configure the first 3D display device 100a-1 and the second 3D display device 100a-2 as a multi-display.

According to an embodiment, the electronic device 200 may configure the first 3D display device 100a-1 and the second 3D display device 100a-2 as a multi-display in response to identifying that the first 3D display device 100a-1 and the second 3D display device 100a-2 are connected to the electronic device 200 via wired connection (e.g., wired connection through an HDMI or USB-C type cable) or wireless connection (e.g., wireless connection through Wi-Fi or Wi-Fi Direct).

According to an embodiment, the electronic device 200 may set multi-display configuration information for configuring the multi-display. The multi-display configuration information may include, e.g., multi-display environment information, multi-display mode information, multi-display layout information, and/or multi-display resolution information. For a description of the multi-display configuration information, the description of the multi-display configuration information of FIG. 4 may be referred to.

According to an embodiment, in operation 920, the electronic device 200 may obtain a 3D display request in the third multi-display environment. Operation 920 may include, e.g., operation 310 of FIG. 3.

According to an embodiment, in operation 930, the electronic device 200 may obtain image data based on the 3D display request. Operation 930 may include, e.g., operation 320 of FIG. 3. The operation of obtaining image data may include, e.g., an operation of converting a 2D format image into a 3D format image.

According to an embodiment, the electronic device 200 may obtain image data based on at least one configuration information. The at least one configuration information may include, e.g., multi-display configuration information, content information, and/or display mode information, but the disclosure is not limited thereto. For a description of the at least one configuration information, the description of the at least one configuration information of FIG. 4 may be referred to.

According to an embodiment, the image data may include 3D format first image data and/or 3D format second image data.

According to an embodiment, in the third multi-display environment, in case that the screen ratio (e.g., 16:9) of the image is the same as the screen ratio (e.g., 16:9) of the 3D display device, and the multi-display mode is the display extension mode (or, display duplication mode), the electronic device 200 may obtain 3D format image data that allows the 3D image converted from the 2D image to be displayed on at least one (e.g., one full screen) of the first 3D display device or the second 3D display device. In case that the multi-display mode is the display extension mode, the electronic device 200 may transmit image data to one of the first 3D display device and the second 3D display device. In case that the multi-display mode is the display duplication mode, the electronic device 200 may transmit the same image data to both the first 3D display device and the second 3D display device.

According to an embodiment, in the third multi-display environment, in case that the screen ratio (e.g., 32:9) of the image is larger than the screen ratio (e.g., 16:9) of the 3D display device, and the multi-display mode is the display extension mode, the electronic device 200 may obtain 3D format image data that allows the 3D image to be displayed on the first 3D display device and the second 3D display device. For example, the electronic device may obtain 3D-format image data including 3D-format first partial image data corresponding to the first portion of the image (e.g., the left half of the 2D image) and second 3D-format second partial image data corresponding to the second portion of the image (e.g., the right half of the 2D image). The electronic device may transmit the first image signal including the first partial image data to the first 3D display device and transmit the second image signal including the second partial image data to the second 3D display device.

According to an embodiment, in the third multi-display environment, in case that the screen ratio (e.g., 16:9) of the image is smaller than the screen ratio (e.g., 32:9) of the 3D display device, and the multi-display mode is the display extension mode (or display duplication mode), the electronic device 200 may obtain 3D format image data that allows the 3D image converted from the 2D image to be displayed on at least one (e.g., at least one full screen or partial screen) of the first 3D display device or the second 3D display device. In case that the multi-display mode is the display extension mode, the electronic device 200 may transmit image data to one of the first 3D display device and the second 3D display device. In case that the multi-display mode is the display duplication mode, the electronic device 200 may transmit the same image data to both the first 3D display device and the second 3D display device.

According to an embodiment, in operation 940, the electronic device 200 may transmit the first image signal including the 3D format first image data to the first 3D display device 100a-1. Operation 940 may include, e.g., operation 330 of FIG. 3. According to an embodiment, in operation 960, the first 3D display device 100a-1 may display the first 3D image based on the first image data. For example, the first 3D display device 100a-1 may display an execution screen (or reproduction screen) including the 3D image based on the first image data. According to an embodiment, operations 940 and 960 may be omitted.

According to an embodiment, in operation 950, the electronic device 200 may transmit the second image signal including the 3D format second image data to the second 3D display device 100a-2. According to an embodiment, in operation 970, the second 3D display device 100a-2 may display the second 3D image based on the second image data. For example, the second 3D display device 100a-2 may display an execution screen (or reproduction screen) including the second 3D image based on the second image data. According to an embodiment, operations 950 and 970 may be omitted.

According to an embodiment, as illustrated in FIGS. 10A and 10B, 3D display requests 1010 and 1020 may be identified in the third multi-display environment including the first 3D display device 100a-1 and the second 3D display device 100a-2. In this case, in case that the screen ratio (e.g., 16:9) of the image is the same as the screen ratio (e.g., 16:9) of the 3D display device, and the multi-display mode is the display extension mode, the first 3D display device 100a-1 or the second 3D display device 100a-2 may display execution screens 1001a and 1002a including 3D images (e.g., 3D images in side-by-side format). For example, as illustrated in FIG. 10B, the first execution screen 1001b of content (e.g., game content) may be displayed on the first 3D display device 100a-1, or the second execution screen 1002b may be displayed on the second 3D display device 100a-2. As described above, in case that the screen ratio of the 2D image and the screen ratio of the 3D display device are the same, it is possible to change only the image format from the 2D format to the 3D format without adjusting the screen ratio of the image and transmit it to the 3D display device. The 3D display device receiving the 3D format image data may display the 3D image on the entire screen based on the image data. Since the 3D image displayed in this way is a 3D image converted from the 2D image without adjusting the screen ratio of the image, the quality of the image may not deteriorate. Accordingly, it is possible to naturally convert a 2D image into a 3D image and provide the 3D image without deterioration of the quality of the image.

According to an embodiment, as illustrated in FIGS. 11A and 11B, in case that the display extension mode is applied in the third multi-display environment, the first 3D display device 100a-1 and the second 3D display device 100a-2 may display the first execution screens 1101a and 1101b and the second execution screens 1102a and 1102b, respectively. After the 3D display request 1110 is identified, if the screen ratio (e.g., 32:9) of the image is larger than the screen ratio (e.g., 16:9) of the 3D display device, the first 3D display device 100a-1 may display the third execution screens 1103a and 1103b including the first 3D image portion (e.g., the first 3D image portion in side-by-side format) corresponding to the first portion of the image, and the second 3D display device 100a-2 may display the fourth execution screens 1104a and 1104b including the second 3D image portion (e.g., the second 3D image portion in side-by-side format) corresponding to the second portion different from the first portion of the image. For example, as illustrated in FIG. 11B, the third execution screen 1103b including the first 3D image portion corresponding to the first portion of the image of the content (e.g., game content) may be displayed on the first 3D display device 100a-1, and the fourth execution screen 1104b including the second 3D image portion corresponding to the second portion of the image may be displayed on the second 3D display device 100a-2. Since the 3D image displayed in this way is a 3D image converted from the 2D image without adjusting the screen ratio of the image, the quality of the image does not deteriorate. Further, since the 3D image is displayed through the plurality of 3D display devices, it may provide a better 3D effect than the 2D multi-display environment in which the 3D image is displayed through one 3D display device.

According to an embodiment, as illustrated in FIGS. 12A and 12B, in case that the display extension mode is applied in the third multi-display environment, the first 3D display device 100a-1 or the second 3D display device 100a-2 may display the first execution screens 1201a and 1201b including an image smaller than the screen ratio of the display. For example, as illustrated in FIG. 12B, the first 3D display device 100a-1 may display the first execution screen 1201b including the image (e.g., the image of game content) that is smaller than the screen ratio of the first 3D display device 100a-1. After the 3D display request 1210 is identified, when the screen ratio (e.g., 16:9) of the image is larger than the screen ratio (e.g., 32:9) of the 3D display device, the first 3D display device 100a-1 or the second 3D display device 100a-2 may display the second execution screens 1202a and 1202b including the 3D image (e.g., the 3D image in side-by-side format) having an adjusted screen ratio. For example, as illustrated in FIG. 12B, the first 3D display device 100a-1 may display the second execution screen 1202b including a 3D image with an adjusted screen ratio (e.g., from 16:9 to 32:9) on the entire screen of the first 3D display device 100-1. Since the so-displayed 3D image is an image with an adjusted screen ratio of the image, slight deterioration of image quality may occur, but since it is provided through the entire screen, a better 3D effect may be provided than when it is provided on a partial screen.

According to an embodiment, an electronic device may identify at least one 3D display device configured as a multi-display, and control the 3D display of the 3D display device. According to an embodiment, the electronic device may control a 3D display of a 3D display device based on at least one configuration information (e.g., multi-display configuration information) in a multi-display environment including the 3D display device. Thus, the usability of the 3D display devices in the multi-display environment may be increased.

According to an embodiment, an electronic device may comprise memory including at least one storage medium storing instructions and at least one processor including a processing circuitry. The at least one processor may obtain a request for three-dimensional 3D display in a state in which a plurality of display devices are connected to the electronic device, the plurality of display devices including a first 3D display device supporting the 3D display, obtain first image data of a 3D format according to multi-display mode information indicating a multi-display mode based on obtaining the request for the 3D display, and transmit

a first image signal including the first image data of the 3D format to the first 3D display device, the multi-display mode being one of a display duplication mode or a display extension mode.

According to an embodiment, the plurality of display devices may further include a two-dimensional (2D) display device supporting 2D display. The multi-display mode may be the display duplication mode. The at least one processor may transmit a second image signal including second image data of the 2D format to the 2D display device. The first image data and the second image data may be image data for the same content.

According to an embodiment, the plurality of display devices may further include a two-dimensional 2D display device supporting 2D display. The multi-display mode may be the display duplication mode. The at least one processor may, based on identifying that at least a portion of an execution screen of the 2D display device is moved to the first 3D display device, convert image data of a 2D format corresponding to the execution screen into the first image data of the 3D format to obtain the first image data of the 3D format.

According to an embodiment, the execution screen corresponding to the first image data of the 3D format may be displayed on an entire screen of the first 3D display device.

According to an embodiment, the first 3D display device may be a display device supporting both the 3D display and the 2D display. The at least one processor may transmit, to the first 3D display device, display mode information for switching a display mode of the first 3D display device from a 2D display mode to a 3D display mode.

According to an embodiment, the display mode information may be included in the first image signal.

According to an embodiment, the plurality of display devices may further include a second 3D display device supporting the 3D display. The multi-display mode may be the display extension mode. The at least one processor may obtain the first image data of the 3D format based on first screen ratio information for a screen ratio of an image and second screen ratio information for a screen ratio of a display to display at least a portion of the image.

According to an embodiment, the at least one processor may The at least one processor may, in case that the screen ratio of the image is identical to the screen ratio of the

display, configure the first image data of the 3D format to be displayed on one of the first 3D display device or the second 3D display device.

According to an embodiment, the at least one processor may, in case that the screen ratio of the image is larger than the screen ratio of the display, obtain first partial image data of the 3D format corresponding to a first portion of the image and second partial image data of the 3D format corresponding to a second portion of the image.

According to an embodiment, the first partial image data may be used to display a first 3D image corresponding to the first portion of the image on the first 3D display device, and the second partial image data may be used to display a second 3D image corresponding to the second portion of the image.

According to an embodiment, a display device may comprise a display, memory including at least one storage medium storing instructions, and at least one processor including a processing circuit. The at least one processor may receive a first image signal including first image data of a 3D format from an electronic device in a state in which a plurality of display devices including the display device are connected to the electronic device, and display a 3D image based on the first image data. The first image data may be image data obtained by the electronic device according to multi-display mode information indicating a multi-display mode based on obtaining a request for 3D display in a state in which the plurality of display devices are connected to the electronic device. The multi-display mode may be one of a display duplication mode or a display extension mode.

According to an embodiment, the plurality of display devices may further include a two-dimensional 2D display device supporting 2D display. The multi-display mode may be the display duplication mode. The first image data may be image data for the same content as second image data transmitted to the 2D display device.

According to an embodiment, the plurality of display devices may further include a two-dimensional 2D display device supporting 2D display. The multi-display mode may be the display extension mode. The first image data of the 3D format may be obtained by, based on identifying that at least a portion of an execution screen of the 2D display device may be moved to the first 3D display device, converting image data of a 2D format corresponding to the execution screen into the first image data of the 3D format to obtain the first image data of the 3D format.

According to an embodiment, the at least one processor may display the execution screen corresponding to the first image data of the 3D format on an entire screen of the first 3D display device.

According to an embodiment, the first 3D display device may be a display device supporting both the 3D display and the 2D display. The at least one processor may receive, from the electronic device, display mode information for switching a display mode of the first 3D display device from a 2D display mode to a 3D display mode.

According to an embodiment, the display mode information may be included in the first image signal.

According to an embodiment, the plurality of display devices may further include a second 3D display device supporting the 3D display. The multi-display mode may be the display extension mode. The first image data of the 3D format may be obtained based on first screen ratio information for a screen ratio of an image and second screen ratio information for a screen ratio of a display to display at least a portion of the image.

According to an embodiment, in case that the screen ratio of the image is identical to the screen ratio of the display, the first image data of the 3D format may be configured to be displayed on one of the first 3D display device or the second 3D display device.

According to an embodiment, in case that the screen ratio of the image is larger than the screen ratio of the display, the first image data of the 3D format may include first partial image data of the 3D format corresponding to a first portion of the image.

According to an embodiment, the first partial image data may be used to display a first 3D image corresponding to the first portion of the image on the first 3D display device.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software including one or more instructions that are stored in a storage medium readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a memory including at least one storage medium configured to store instructions; and
at least one processor including processing circuitry, the at least one processor configured to:
with a connection to a plurality of display devices including a three-dimensional (3D) display device that supports 3D display,
obtain a request for 3D display,
based on the obtained request for 3D display, obtain image data in a 3D format according to multi-display mode information that indicates the plurality of display devices are in a multi-display mode, and
transmit, to the 3D display device among the plurality of display devices, an image signal including the image data that allows the 3D display device to display a 3D image corresponding to the image data,
wherein the multi-display mode is one of a display duplication mode and a display extension mode.

2. The electronic device of claim 1, wherein
the image signal is a first image signal,
the plurality of display devices further includes a two-dimensional (2D) display device that supports 2D display,
the multi-display mode is the display duplication mode, and
the at least one processor is further configured to:
with a connection to the plurality of display devices including the 3D display device and the 2D display device,
transmit, to the 2D display device, a second image signal including image data in a 2D format, the image data in the 2D format and the image data in the 3D format being image data for a same content.

3. The electronic device of claim 1, wherein
the plurality of display devices further includes a two-dimensional (2D) display device that supports 2D display,
the multi-display mode is the display extension mode, and
the at least one processor is further configured to:
with a connection to the plurality of display devices including the 3D display device and the 2D display device,
identify whether a portion of an execution screen of the 2D display device is moved to the 3D display device,
based on identification that the portion of an execution screen of the 2D display device is moved to the 3D display device, convert image data in a 2D format that corresponds to the execution screen into image data in the 3D format to obtain the image data in the 3D format.

4. The electronic device of claim 3, wherein an execution screen corresponding to the image data in the 3D format is displayed on an entire screen of the 3D display device.

5. The electronic device of claim 3, wherein
the 3D display device supports both 3D display and 2D display, and
the at least one processor is further configured to:
with the connection to the plurality of display devices including the 3D display device and the 2D display device,
transmit, to the 3D display device, display mode information for switching a display mode of the 3D display device from a 2D display mode to a 3D display mode.

6. The electronic device of claim 5, wherein the display mode information is included in the image signal.

7. The electronic device of claim 1, wherein
the 3D display device is a first 3D display device,
the plurality of display devices further includes a second 3D display device that supports 3D display,
the multi-display mode is the display extension mode, and
the at least one processor is further configured to:
with a connection to the plurality of display devices including the first 3D display device and the second 3D display device,
obtain the image data in the 3D format based on first screen ratio information for a screen ratio of an image and second screen ratio information for a screen ratio of a first display screen of the first 3D display device and/or a screen ratio of a second display screen of the second 3D display device such that at least a first portion of the image is displayable on the first display screen and at least a second portion of the image is displayable on the second display screen.

8. The electronic device of claim 7, wherein
the at least one processor is further configured to:
with the connection to the plurality of display devices including the first 3D display device and the second 3D display device, and based on the screen ratio of the image being identical to the screen ratio of the first display screen and/or the screen ratio of the second display screen, configure image data in the 3D format to be displayed on the first 3D display device or the second 3D display device.

9. The electronic device of claim 7, wherein
the at least one processor is further configured to:
with the connection to the plurality of display devices including the first 3D display device and the second 3D display device and based on the screen ratio of the image being larger than the screen ratio of the first display screen and/or the screen ratio of the second display screen, obtain first partial image data in the 3D format corresponding to a first portion of the image and second partial image data in the 3D format corresponding to a second portion of the image.

10. The electronic device of claim 9, wherein
based on the obtained first partial image data, a first 3D image corresponding to the first portion of the image is displayed on the first 3D display device, and
based on the obtained second partial image data, a second 3D image corresponding to the second portion of the image is displayed on the second 3D display device.

11. A display device, comprising:
a display that supports three-dimensional (3D) display;
a memory including at least one storage medium configured to store instructions; and
at least one processor including processing circuitry, the at least one processor configured to:
with a connection to another display device and an electronic device,
receive, from the electronic device, an image signal including image data in a 3D format that allows the display to display a 3D image corresponding to the image data, and
display the 3D image based on the received image data,
wherein the image data is obtained by the electronic device according to multi-display mode information that indicates the display device and the another display device are in a multi-display mode, and
the multi-display mode is one of a display duplication mode and a display extension mode.

12. The display device of claim 11, wherein
the image data is first image data,
the another display device further includes a two-dimensional (2D) display device that supports 2D display,
the multi-display mode is the display duplication mode, and
the first image data is for a same content as second image data that is transmitted by the electronic device to the 2D display device.

13. The display device of claim 11, wherein
the another display device is a two-dimensional (2D) display device that supports 2D display,
the multi-display mode is the display extension mode, and
wherein the first image data of the 3D format is obtained by, based on identification that a portion of an execution screen of the another display device is moved to the display, converting image data in a 2D format that corresponds to the execution screen into the image data in the 3D format as at least part of the received image data.

14. The display device of claim 13, wherein
the at least one processor is further configured to:
with the connection to the another display device and the electronic device,
display an execution screen corresponding to the image data in the 3D format on an entire screen of the display.

15. The display device of claim 13, wherein
the display supports both 3D display and 2D display, and
the at least one processor is further configured to:
with the connection to the another display device and the electronic device,
receive, from the electronic device, display mode information for switching a display mode of the display from a 2D display mode to a 3D display mode.
